(19) United States
(12) Patent Application Publication
(10) Pub. No.: US 2003/0023836 A1
(43) Pub. Date: Jan. 30, 2003

(54) Shadow register array control instructions

(76) Inventors: Michael Catherwood, Pepperell, MA (US); Joseph W. Triece, Phoenix, AZ (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,463

(22) Filed: Jun. 1, 2001

(51) Int. Cl. G06F 9/00

(52) U.S. Cl. 712/225; 712/228

(57) ABSTRACT

A method and processor for shadow register array instruction processing are provided. Shadow register array control instructions are executed on data in a source array of registers to write the data simultaneously to a destination array of registers. The shadow array control instructions are available to perform context saving of the data during interrupt and non-interrupt processing. The shadow register array control instruction may write data stored in an array of primary registers to an array of shadow registers. Alternatively, the shadow register array control instruction may write data stored in an array of shadow registers to an array of primary registers.

### BACKGROUND OF THE INVENTION

1. Field of the Invention

The present invention relates to systems and methods for instruction processing and, more particularly, to systems and methods for providing shadow register array control instruction processing, pursuant to which data contained in data memory is transferred from a source location in data memory to a destination location in data memory.

2. Description of the Prior Art

Processors, including microprocessors, digital signal processors and microcontrollers, operate by running software programs that are embodied in one or more series of instructions stored in a memory. The processors run the software by fetching instructions from the series of instructions, decoding the instructions and executing them. The instructions themselves control the order in which the processor fetches and executes the instructions. For example, the order for fetching and executing each instruction may be inherent in the order of the instructions within the series. Alternatively, instructions such as branch instructions, conditional branch instructions, subroutine calls and other “flow control” instructions may cause instructions to be fetched and executed out of the inherent order of the instruction series.

When a processor fetches and executes instructions in the inherent order of the instruction series, the processor may execute the instructions very efficiently without saving data to, and restoring from, registers to enable access to the data for processing. When flow control instructions are processed, one or more processor cycles may be wasted while the processor saves data that is not required to execute the flow control instructions to registers and restores the data from the registers to execute instructions following the flow control instructions that require the data.

Like flow control instructions, interrupts may cause instructions to be fetched and executed out of the inherent order of the instruction series. Conditions that generate an interrupt during program execution may be embodied in a number of forms. These embodiments may include a stack overflow, an address error, an instruction error, an arithmetic error and various priority interrupts designed to give effect to various input/output programs or other processes. Upon the occurrence of any of the aforementioned conditions, an interrupt flag is set signaling the processor to determine priority between the interrupt and the processor. Servicing of the interrupt typically follows a determination of interrupt priority. Servicing may include fetching and executing an interrupt servicing routine (hereinafter “ISR”). In servicing an interrupt, one or more processor cycles may be wasted while the processor saves data that is not required to execute instructions in the ISR to registers and restores the data from the registers to execute instructions following the ISR that require the data.

Typically, processors, including microprocessors, digital signal processors and microcontrollers, saves data to, and restores data from, registers by implementing a software subroutine or a software loop within a program. Software loops and subroutines make inefficient use of processor resources and tend to reduce the performance of the processor. The instructions for saving data to, and restoring data from, registers are typically limited to entry to, and exit from, an ISR for an interrupt. Moreover, the instructions to save data to, and restore data from, registers are performed automatically as part of servicing the interrupt. As a result, programmers lack the flexibility to define the conditions when saving data to, and restoring data from, registers occur.

There is a need for a new method of implementing shadow register array control instructions within a processor that makes efficient use of processor cycles and instructions efficiently. There is a further need for a new method of implementing shadow register array control instructions that provide programmers with the flexibility to define the conditions when saving data to, and restoring data from, registers occur. There is also a need to perform context saving of data not requiring immediate access during interrupts not implementing automatic saving and restoring. There is a need to store a set of data simultaneously and quickly during interrupt processing.

### SUMMARY OF THE INVENTION

According to embodiments of the present invention, a method and a processor for processing shadow register array control instructions are provided. The shadow register array control instructions themselves include two instructions, each for writing data contained in a source array of registers, simultaneously, to a destination array of registers. These instructions may be executed in one processor cycle and with one program instruction employing shadow register control logic within the processor. The instructions are offered for implementation in non-interrupt and interrupt applications where quick and efficient data context saving is desired.

A method for processing shadow register array control instructions according to an embodiment of the present invention includes fetching and decoding a shadow register array control instruction. The shadow register array control instruction is executed on data in a source array of registers to write the data simultaneously to a destination array of registers. The shadow array control instructions are available to perform context saving of the data during interrupt and non-interrupt processing.

In an embodiment of the present invention, the shadow register array control instruction may be a first shadow register array control instruction. The first shadow register array control instruction writes data stored in an array of primary registers to an array of shadow registers. Alternatively, the shadow register array control instruction may be a second shadow register array control instruction. The second shadow register array control instruction writes data stored in an array of shadow registers to an array of primary registers.

In an embodiment of the present invention, the method further includes detecting that an interrupt condition has occurred and loading the first shadow register array instruction into an instruction register for execution. An interrupt service routine (ISR) for servicing the interrupt condition provides the first shadow array instruction as a first instruction in the ISR. The first shadow register array control instruction writes data stored in an array of primary registers to an array of shadow registers.

In an embodiment of the present invention, the method further includes detecting that an interrupt condition has occurred and executing remaining instructions in an ISR for servicing the interrupt condition. The remaining instructions include a return from ISR routine with an automatic context save option disabled. The method further includes loading a second shadow register array instruction into an instruction register for execution before executing the return from ISR routine. The second shadow register array control instruction writes data stored in an array of shadow registers to an array of primary registers.

According to an embodiment of the present invention, a processor for performing shadow register array control instructions includes an array of primary registers for storing data, an array of shadow registers for storing data, and a program memory for storing instructions including a shadow register array control instruction. The processor further includes s program counter for identifying current instructions for processing and a shadow register array control logic for executing the shadow register array control instruction on data stored in a source array of registers. The shadow register array control instruction writes the data from the source array of registers to a destination array of registers. The shadow register control instruction is configured to provide a fast context save during interrupt and non-interrupt processing.

### BRIEF DESCRIPTION OF THE DRAWINGS

The above described features and advantages of the present invention will be more fully appreciated with reference to the detailed description and appended figures in which:

The above described features and advantages of the present invention will be more fully appreciated with reference to the detailed description and appended figures in which:

FIG. 1 depicts a functional block diagram of an embodiment of a processor chip within which embodiments of the present invention may find application;

FIG. 2 depicts a functional block diagram of a data busing scheme for use in a processor, which has a microcontroller and a digital signal processing engine, within which embodiments of the present invention may find application;

FIG. 3 depicts a functional block diagram of a processor configuration for processing shadow register array control instructions according to embodiments of the present invention;

FIG. 4A-4B depict a method of processing shadow register array control instructions according to embodiments of the present invention; and

FIG. 5 depicts a table of shadow register array control instructions according to embodiments of the present invention.

### DETAILED DESCRIPTION OF THE INVENTION

According to the present invention, a method and processor for processing shadow register array control instructions are provided. More particularly, a first shadow register array control instruction writes data to an array of shadow registers from an array of primary registers. The first shadow register array control instruction may be the first instruction in an interrupt service routine (ISR) associated with a detected interrupt condition. The first shadow register array control instruction may be loaded into an instruction register for execution. A second shadow register array control instruction writes data to an array of primary registers from an array of shadow registers. The second shadow register array control instruction may be an instruction in an ISR associated with an interrupt being serviced where an automatic context saving option in a return from ISR routine of the ISR is disabled. The second shadow register array control instruction is loaded for execution before executing the return from ISR routine.

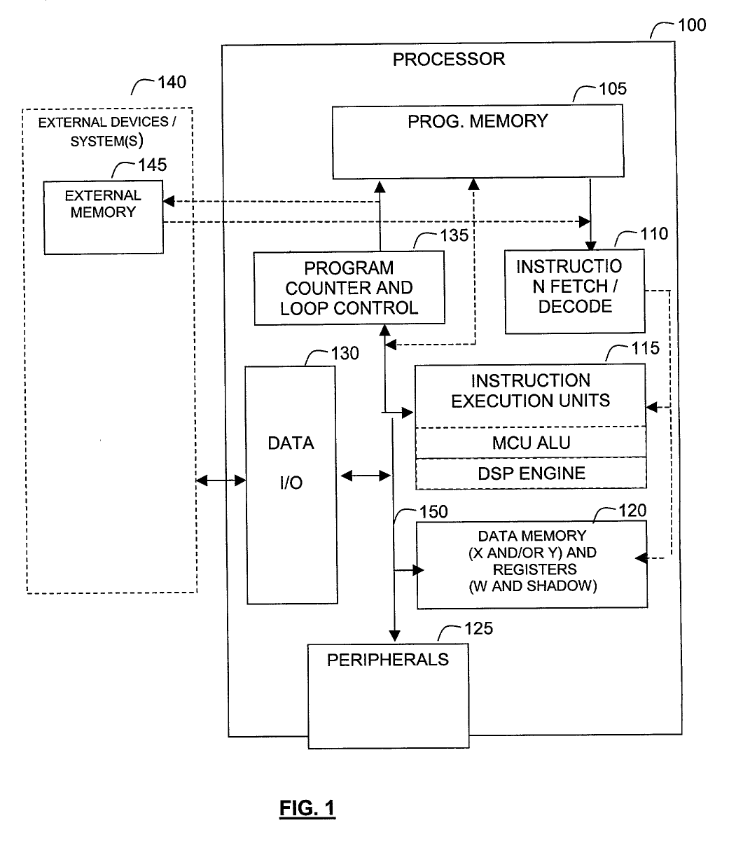

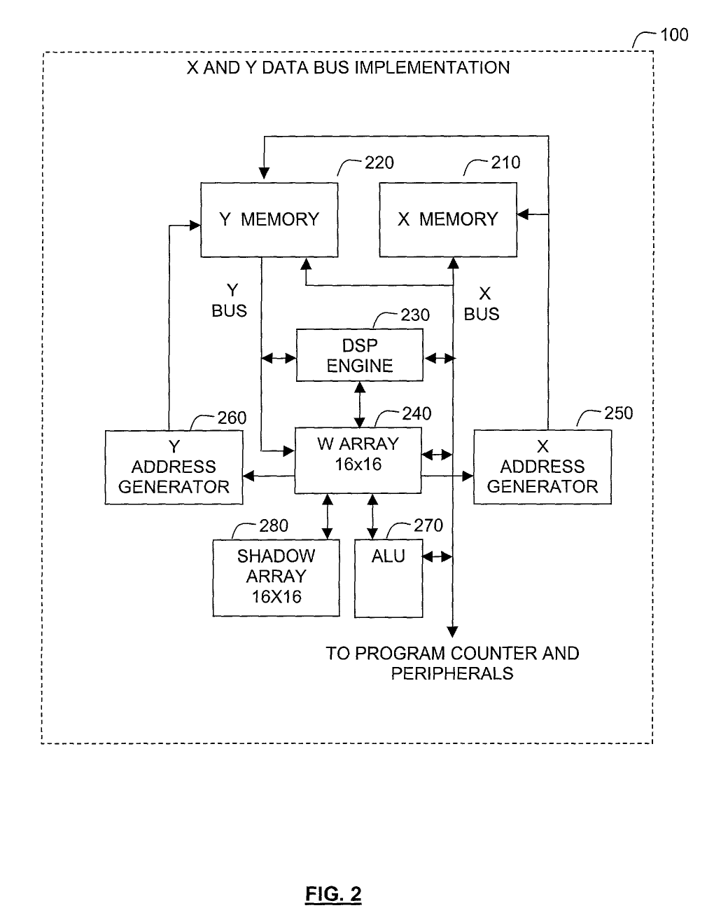

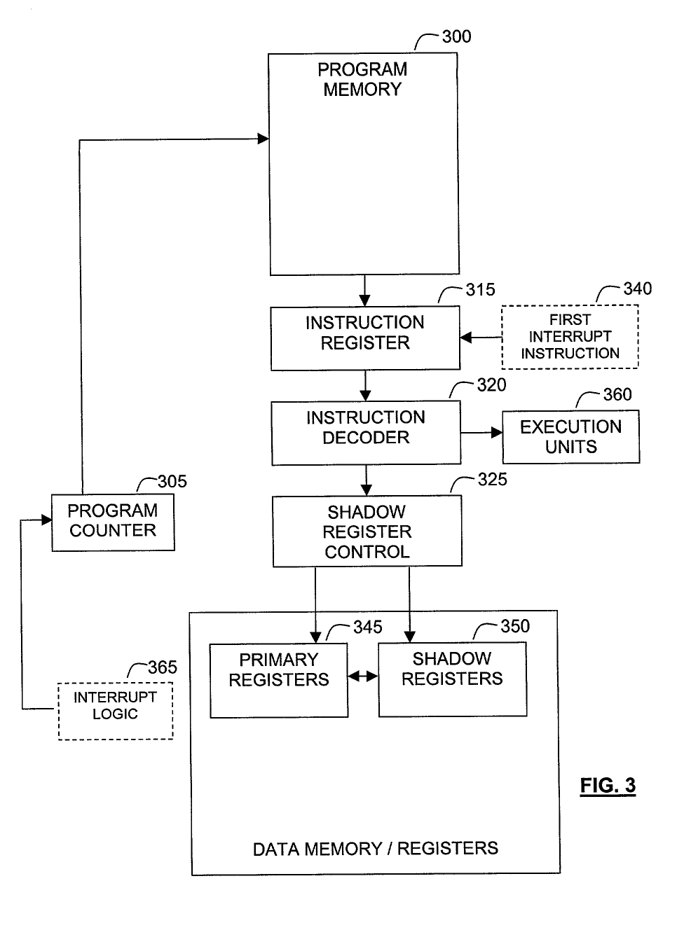

In order to describe embodiments of shadow register array control instruction processing, an overview of pertinent processor elements is first presented with reference to FIGS. 1 and 2. The shadow register array control instructions and instruction processing is then described more fully with reference to FIGS. 3-5.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 150. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. In order to preserve data information contained in W registers 240, while processing affecting flow control is performed, the data information contained in the W registers 240 may be saved to an array of shadow registers 280. After the processing affecting flow control is performed, the data information contained in the shadow register 280 may be restored to the primary registers, thus permitting processing using the data information to resume. The W registers 240 are communicatively coupled to shadow registers 280, where each bit in the array of primary registers 240 is in communication with a bit in the array of shadow registers 280.

The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:

| | |
|---|---|
| Q1: | Fetch Instruction |
| Q2: | Fetch Instruction |
| Q3: | Fetch Instruction |
| Q4: | Latch Instruction into prefetch register, Increment PC |

The following sequence of events may comprise, for example, the execute instruction cycle for a single operand instruction:

| | |
|---|---|
| Q1: | latch instruction into IR, decode and determine addresses of |
| | operand data |
| Q2: | fetch operand |
| Q3: | execute function specified by instruction and calculate destination |
| | address for data |
| Q4: | write result to destination |

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.

| | |
|---|---|
| Q1: | latch instruction into IR, decode and determine addresses of |
| | operand data |
| Q2: | pre-fetch operands into specified registers, execute operation in |
| | instruction |
| Q3: | execute operation in instruction, calculate destination address |
| | for data |
| Q4: | complete execution, write result to destination |

Shadow Array Control Instruction Processing

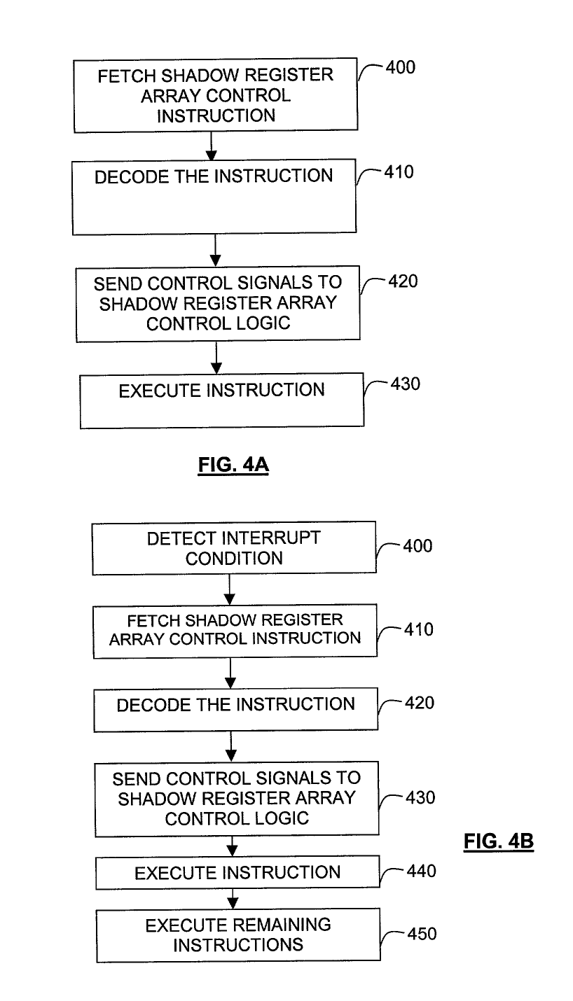

FIG. 3 depicts a functional block diagram of a configuration for processing shadow register array control instructions according to an embodiment of the present invention. Referring to FIG. 3, the processor includes a program memory 300 for storing instructions, such as the shadow register array control instructions depicted in FIG. 4B. The processor also includes a program counter 305 that stores a pointer to the next program instruction to be fetched. The processor further includes an instruction register 315 for storing an instruction for execution that has been fetched from the program memory 300. The processor also includes an instruction decoder 320, shadow register control logic 325, primary registers 345 (W registers), and shadow register 350.

Primary registers 345 can contain data values that the processor may require immediate access to during the course of processing. The primary registers may include registers, such as a set of working registers, a program counter register, a repeat loop counter register, a do loop count register and a status register.

Shadow registers 350 can temporarily store data values that the processor may not require immediate access to in order to execute an instruction. A shadow register may be provided for each primary register in the array of primary registers 345. Each shadow register can transfer their contents to, or from, a corresponding primary register upon the execution of a shadow register array control instruction.

The instruction decoder 320 decodes instructions that are stored in the instruction register 315. Based on the bits in the instruction, the instruction decoder 320 selectively activates shadow register control logic 325 for performing the specified operation on primary registers 345 and shadow registers 350.

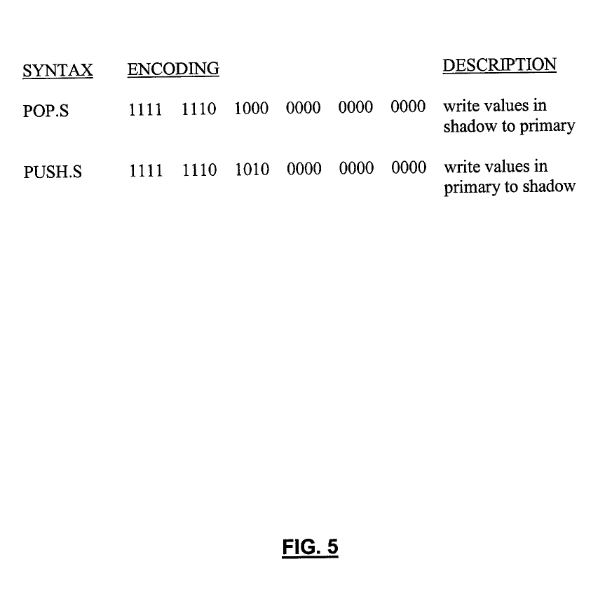

The shadow register control logic 325 is activated upon the decoding and execution of a shadow register array control instruction shown in FIG. 4B. The logic 325 may be provided as an array of localized communication buses. Each bus in the array of localized buses couples a bit position of a primary register to a bit position of a shadow register. In this regard, when a shadow register array control instruction, such as one of those depicted in FIG. 5, is present to the instruction decoder 320, the instruction decoder generates control signals which cause the shadow register control logic 325 to write data stored in an array of source registers to an array of destination registers. The array of registers designated as the source and destination depends upon the bits in the instruction executed in the table of FIG. 5.

At any time during the processing of an instruction by the processor, an interrupt condition may occur and be serviced as determined by interrupt logic 365. When an interrupt is serviced, program counter 350 loads into the program counter 350 the address of interrupt service routine instructions for the interrupt condition. In order to preserve the data values contained in the primary registers 345 while the interrupt is serviced, the data values contained in the primary registers 345 may be written from the primary registers 345 to shadow registers 350. The data may be stored by providing a first shadow register array control instruction as the first instruction in the ISR for the interrupt condition for execution. The first shadow register array control instruction writes data contained in an array of primary registers to an array of shadow registers. The remaining instructions of the ISR are executed. The remaining instructions may include a return from ISR routine. The return from ISR instruction may include an automatic context save option. When the automatic context save option in the return from ISR routine is disabled, the data values contained in the array of shadow registers is not automatically written from the array of shadow register to the array of primary registers. The ISR may include a second shadow register array control instruction that writes data contained in the array of shadow registers to an array of primary registers. The second shadow register array control instruction is performed prior to execution of the return from ISR routine.

FIG. 4A depicts a method of processing shadow register array control instructions according to embodiments of the present invention. Referring to FIG. 4A, in step 400A, the processor fetches a shadow array control instruction from the program memory 300. Then in step 410A, the instruction decoder 320 decodes the instruction. In step 420A, the processor causes control signals to be sent to the shadow register array control logic 325. In step 430A, the processor executes the shadow register array control instruction decoded.

FIG. 4B depicts a method of processing shadow register array control instructions according to embodiments of the present invention. Referring to FIG. 4B, in step 400B, an interrupt condition is detected. In Step 410B, the processor fetches an instruction from the program memory 300. The instruction can be a shadow register control instruction to write the data values contained in an array of primary registers to an array of shadow registers. The shadow register array control instruction can be provided as the first instruction in the ISR. Then in step 420B, the instruction decoder 320 decodes the instruction. In step 430B, the processor causes control signals to be sent to the shadow register array control logic 325. In step 440B, the processor executes the shadow register array control instruction decoded. In step 450B, the remaining instructions in the ISR are executed. The remaining instruction may include a return from ISR routine and a second shadow register array control instruction. If a context save option of the return from ISR routine is disabled, the second shadow register array control instruction may be performed prior to execution of the return from ISR routine to write the data values contained in an array of shadow registers to an array of primary registers.

While specific embodiments of the present invention have been illustrated and described, it will be understood by those having ordinary skill in the art that changes may be made to those embodiments without departing from the spirit and scope of the invention.

What is claimed is:

1. A method for processing shadow register array control instructions, comprising:
fetching and decoding a shadow register array control instruction;
executing the shadow register array control instruction on data stored in a source array of registers to write the data from the source array of registers to a destination array of registers, the shadow array control instruction configured to provide a fast context save during interrupt and non-interrupt processing.

2. The method according to claim 1, wherein the shadow register array control instruction is a first shadow array control instruction.

3. The method according to claim 2, wherein the source array of registers is a primary register array and the destination array of registers is a shadow register array.

4. The method according to claim 3, further comprising:
detecting that an interrupt condition has occurred.

5. The method according to claim 4, further comprising:
loading the first shadow register array instruction into an instruction register for execution, the first shadow array instruction provided as a first instruction in an interrupt service routine (ISR) for an interrupt servicing the interrupt condition.

6. The method according to claim 1, wherein the shadow register array control instruction is a second shadow array control instruction.

7. The method according to claim 2, wherein the source array of registers is a shadow register array and the destination array of registers is a primary register array.

8. The method according to claim 7, further comprising:
detecting that an interrupt condition has occurred.

9. The method according to claim 8, further comprising:
executing remaining instructions in an ISR for an interrupt servicing the interrupt condition, the remaining instructions including a return from the ISR routine, wherein an automatic context save option in the return from the ISR routine is disabled.

10. The method according to claim 9, wherein the second shadow register array control instruction is executed before the execution of the return from the ISR routine.

11. A processor for performing shadow register array control instructions, comprising:
an array of primary registers for storing data;
an array of shadow registers for storing data;
a program memory for storing instructions including a shadow register array control instruction;
a program counter for identifying current instructions for processing; and
a shadow register array control logic for executing the shadow register array control instruction on a data stored in a source array of registers to write the data from the source array of registers to a destination array of registers, the shadow register control instruction configured to provide a fast context save during interrupt and non-interrupt processing.

12. The processor according to claim 11, wherein the shadow register array control instruction is a first shadow array control instruction.

13. The processor according to claim 12, wherein the source array of registers is the array of primary registers and the destination array of registers is the array of shadow registers.

14. The processor according to claim 12, further comprising:
interrupt logic for detecting that an interrupt condition has occurred.

15. The processor according to claim 14, further comprising:
an instruction register for loading the first shadow register array control instruction for execution, the first shadow array instruction provided as a first instruction in an interrupt service routine (ISR) for an interrupt servicing the interrupt condition.

16. The processor according to claim 11, wherein the shadow register array control instruction is a second shadow array control instruction.

17. The processor according to claim 11, wherein the source array of registers is the array of shadow registers and the destination array of registers is the array of primary registers.

18. The processor according to claim 16, further comprising:
interrupt logic for detecting that an interrupt condition has occurred.

19. The processor according to claim 18, further comprising:
an execution unit for executing remaining instructions in an ISR for an interrupt servicing the interrupt condition, the remaining instructions including a return from the ISR routine, wherein an automatic context save option in the return from the ISR routine is disabled.

20. The processor according to claim 19, wherein the second shadow register array control instruction is executed before the execution of the return from the ISR routine.
